(19) United States
(12) Patent Application Publication
(10) Pub. No.: US 2024/0403064 A1
(43) Pub. Date: Dec. 5, 2024

(54) DETECTION OF AIRCRAFT TRAVEL BY A MOBILE DEVICE

(71) Applicant: Benjamin GUILD, Covina, CA (US)

(72) Inventor: Benjamin GUILD, Covina, CA (US)

(21) Appl. No.: 18/426,286

(22) Filed: Jan. 29, 2024

Related U.S. Application Data
(60) Provisional application No. 63/470,382, filed on Jun. 1, 2023.

(51) Int. Cl. G06F 9/4401; G06F 3/0346

(52) U.S. Cl. CPC G06F 9/4411; G06F 3/0346

(57) ABSTRACT

The techniques herein are directed generally to determining or categorizing movement of a user via their user device, and specifically to detection of aircraft travel by a mobile device. In particular, according to one or more embodiments described herein, methods and/or apparatus are shown for determining that a user is in a particular mode of travel (e.g., traveling by aircraft) via a mobile device such as a smart phone by using various detected parameters including data from the sensors on that device or a sibling device such as the Inertial Measurement Unit (IMU) bearing an accelerometer, magnetometer, and/or gyroscope, and the device's atmospheric pressure barometer.

### RELATED APPLICATIONS

This application claims priority to U.S. Provisional Application No. 63/441,536, filed Jan. 27, 2023, and U.S. Provisional Application No. 63/470,382, filed Jun. 1, 2023, both entitled SENSOR-TRIGGERED SOCIAL LOCATIONAL INTERACTIONS USING SMART DEVICES, by Benjamin Guild, the contents of which are incorporated herein by reference.

### TECHNICAL FIELD

This disclosure relates generally to the field of mobile device movement classification, and, in particular, to computer-implemented systems and methods for detection of aircraft travel by a mobile device.

### BACKGROUND

Mobile phones and other mobile devices have become an integral part of modern society, and there are several reasons why they are used so frequently. One reason is that they provide easy and immediate access to information and communication. People can easily look up information, check email, and stay connected with friends and family through various forms of social media and messaging. Additionally, many people use mobile phones for entertainment, such as watching videos, playing games, and listening to music. Additionally, mobile devices, such as fitness trackers, watches, headphones, tablets, and so on, each offer their own advantages and have their own functionalities that have become ubiquitous for the modern traveler.

Another reason for the popularity of mobile phones, in particular, is their convenience and portability. People can take their mobile phones with them wherever they go, which means that they can stay connected and access information at all times. Mobile phones also have a wide range of features and capabilities, such as cameras, location determination and navigation services (e.g., global positioning satellite, or “GPS” technology), and the ability to run apps, making them useful for a variety of tasks.

However, allowing these personal mobile devices to continuously track your GPS and location information can have serious implications for both privacy and security. Firstly, it raises significant privacy concerns as it allows companies and potentially malicious actors to gather extensive information about your whereabouts, daily routines, and personal habits. This data can be exploited for targeted advertising, surveillance, or even nefarious purposes. Furthermore, the accumulation of location data over time creates a comprehensive digital footprint that, if accessed by unauthorized parties, can pose a substantial threat to one's personal privacy. Additionally, excessive location tracking can drain your device's battery and compromise its overall performance. Lastly, the risk of data breaches and the potential for location data to fall into the wrong hands highlight the importance of maintaining control over this sensitive information. In summary, permitting tracking of location information can have detrimental consequences for privacy, security, and the overall functionality of your device.

### SUMMARY

The techniques herein are directed generally to determining or categorizing movement of a user via their user device. In particular, according to one or more embodiments described herein, methods and/or apparatus are shown for determining that a device (e.g., and thus an associated user) is traveling or has traveled by aircraft (e.g., a passenger plane, cargo plane, drone, or other modes of air travel) by using various detected parameters including data from the device's environmentally reactive sensors such as an Inertial Measurement Unit (IMU) bearing an accelerometer, magnetometer, and/or gyroscope, and/or the device's atmospheric pressure barometer. Notably, the techniques herein may function without the use of GPS tracking or other electronic locating services (e.g., by radio-frequency signal analysis such as that of Wi-Fi or cellular equipment with resolvable or known associated locations, as well as other near-field communication (NFC) or Bluetooth® technologies that offer location precision) specifically, though in certain embodiments, GPS or locating services may be used as a feature enhancement once aircraft travel has already been detected, accordingly.

In one embodiment, the techniques herein are directed generally to classifying movement of a user when the user's device is traveling by aircraft. In particular, according to one or more embodiments described herein, methods and/or apparatus are shown for using various sensors on a mobile device and analyzing the data received from those sensors to classify movement as movement associated with flight, when the data received indicates changes, such as sudden, rapid, and often extended changes in acceleration, altitude, and pressure that fit a recognized pattern and profile observed during air travel.

Specifically, in one embodiment herein, an illustrative method may comprise: obtaining, by a process, data from one or more environmentally reactive sensors (e.g., inertial sensors) of a particular device; analyzing, by the process, the data for motion characteristics associated with movement of devices during aircraft travel; determining, by the process and based on analyzing, that the particular device was traveling by aircraft based on a given portion of the data substantially sharing the motion characteristics associated with movement of devices during aircraft travel; and causing, by the process, one or more air travel related software actions on the particular device in response to determining that the particular device was traveling by an aircraft at a time associated with the given portion of the data.

While various embodiments have been discussed in the summary above, it should be appreciated that not necessarily all embodiments include the same features and some of the features described above are not necessary for all embodiments. Numerous additional features, embodiments, and benefits of various embodiments are discussed in the detailed description which follows.

### BRIEF DESCRIPTION OF THE DRA WINGS

The embodiments herein may be better understood by referring to the following description in conjunction with the accompanying drawings in which like reference numerals indicate identically or functionally similar elements, of which:

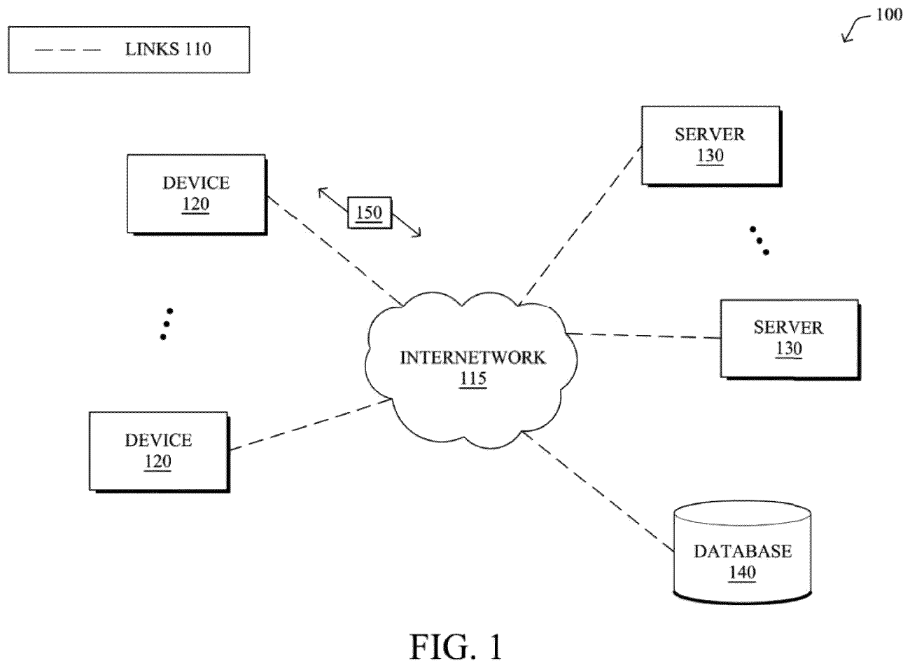

FIG. 1 illustrates an example simplified computer network;

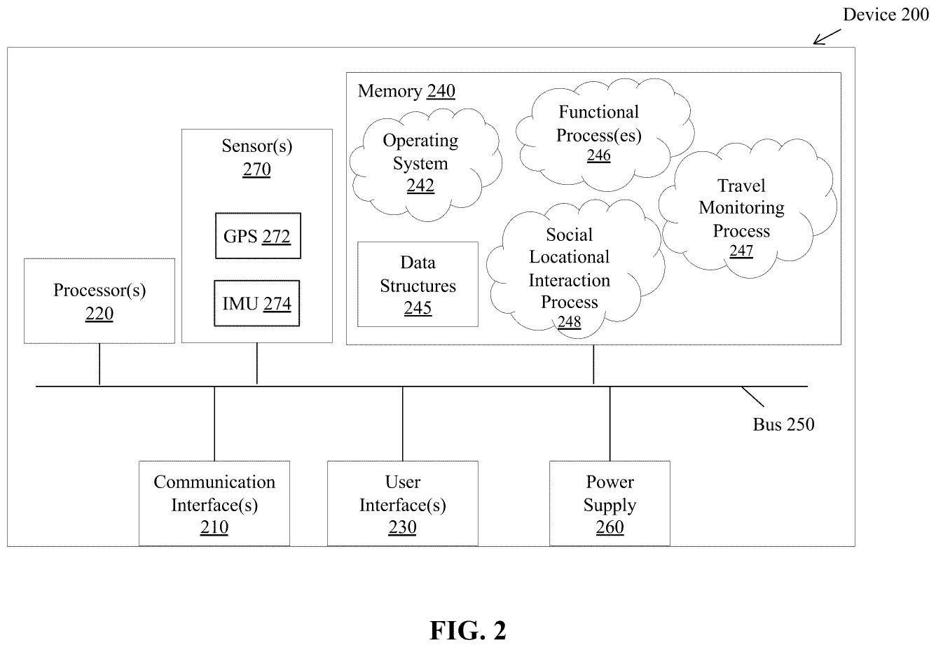

FIG. 2 illustrates an example of a computing device;

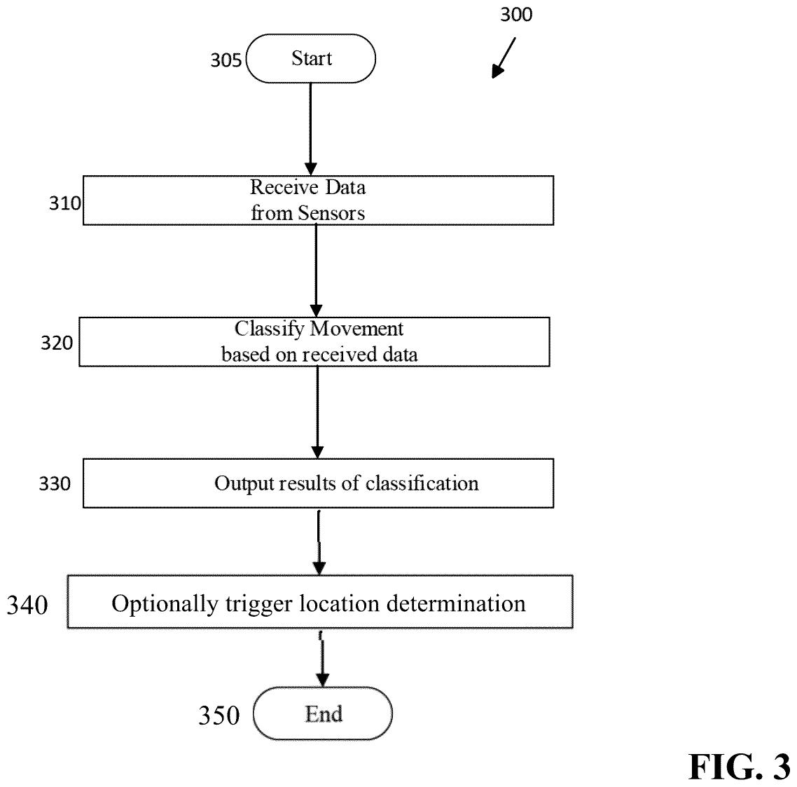

FIG. 3 illustrates an example simplified procedure for classifying movement of a user's device into a categorical mode of transportation;

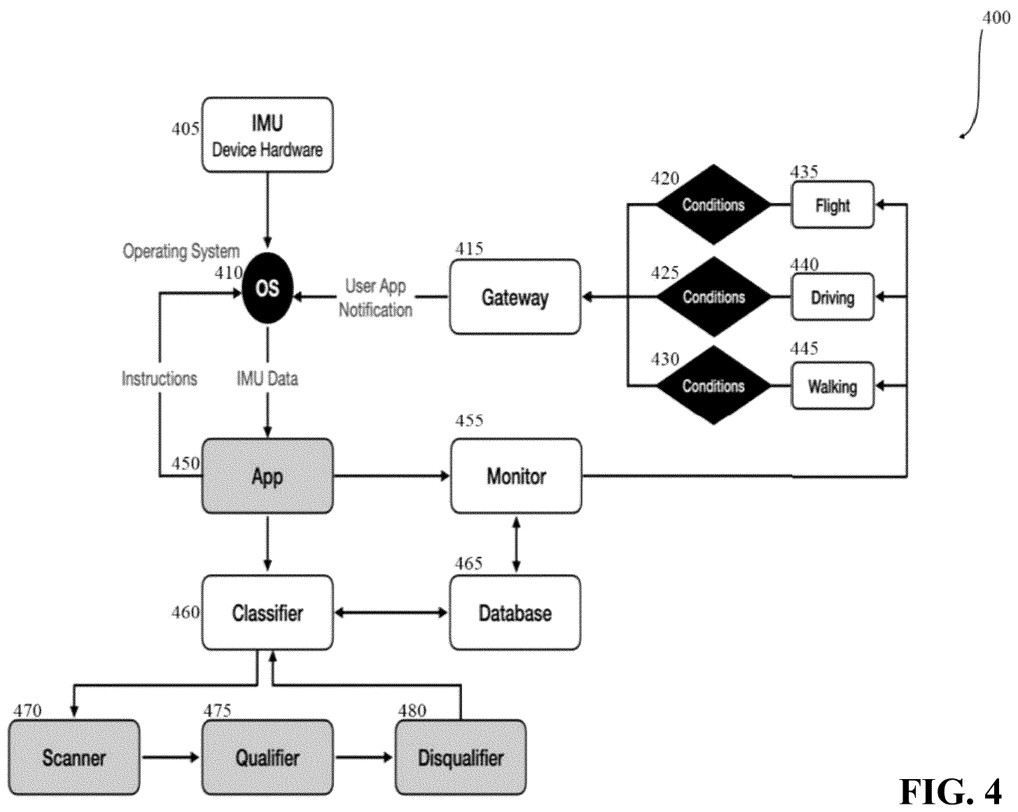

FIG. 4 illustrates an example architecture for classifying movement of a user's device;

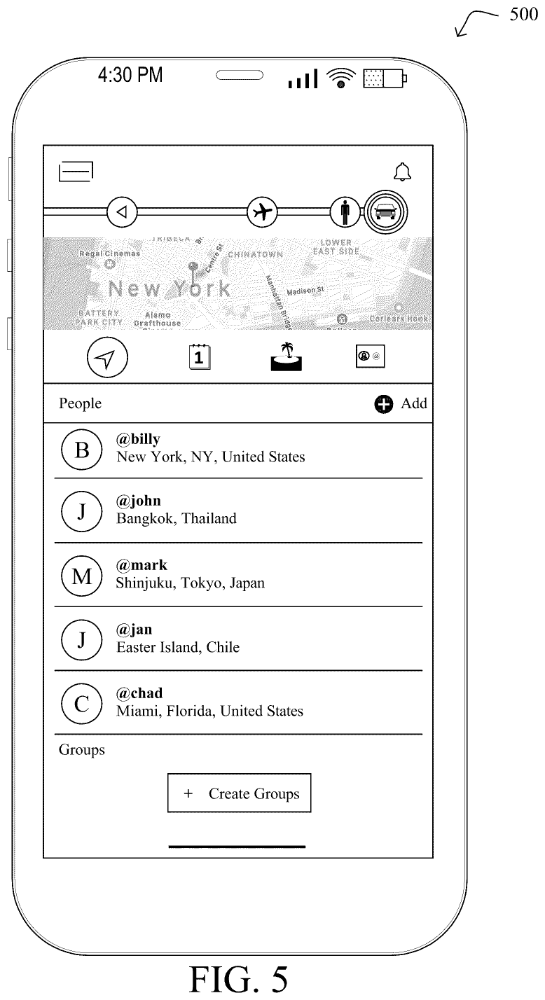

FIG. 5 illustrates an example user interface integrating the classified mode of transportation;

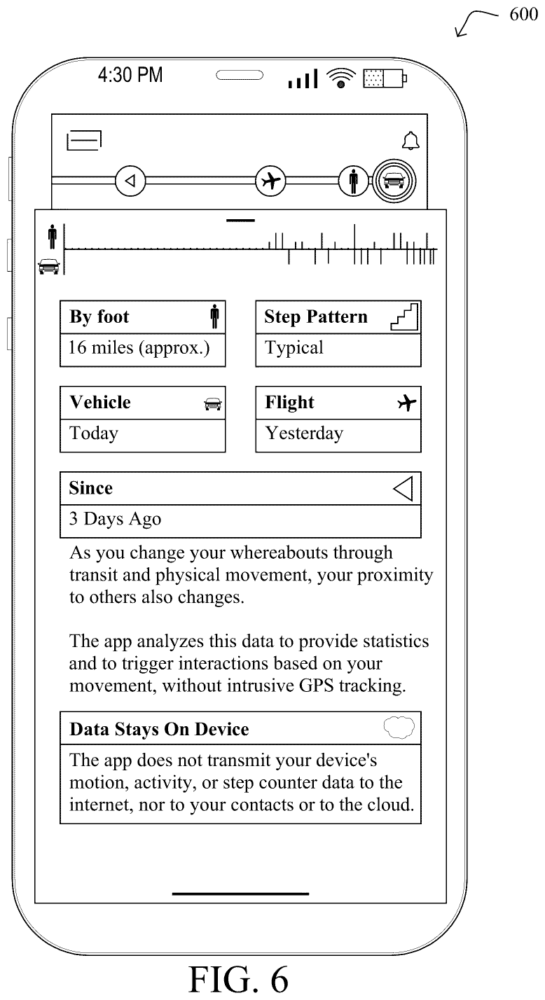

FIG. 6 illustrates another example user interface integrating the classified mode of transportation;

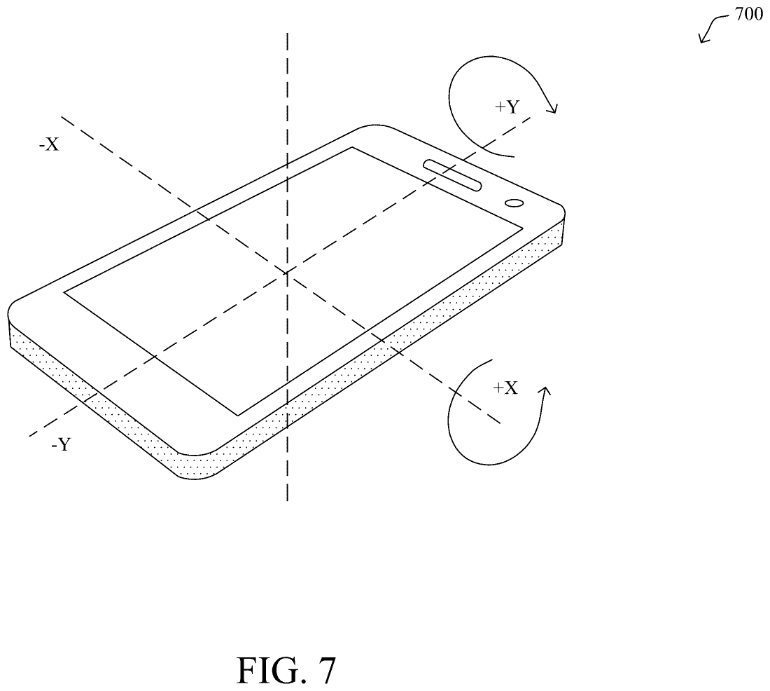

FIG. 7 illustrates an example of inertial sensors;

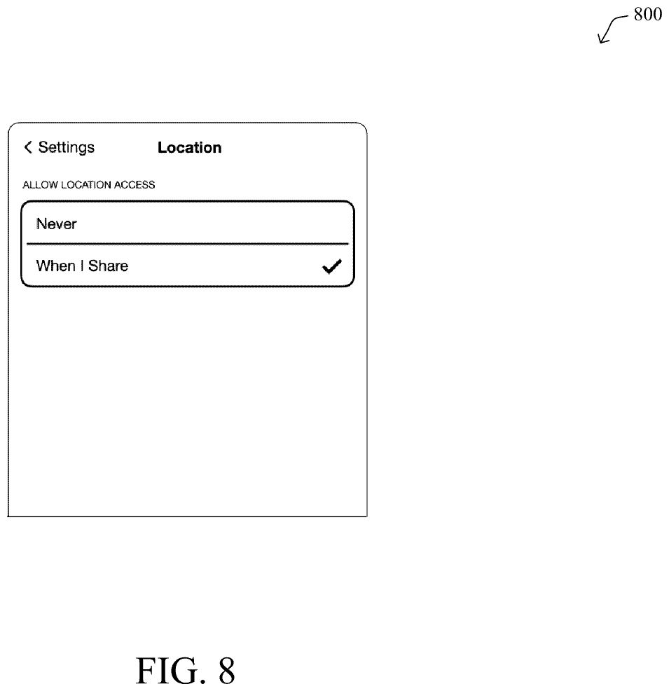

FIG. 8 illustrates an example GUI of location sharing settings on a smart device;

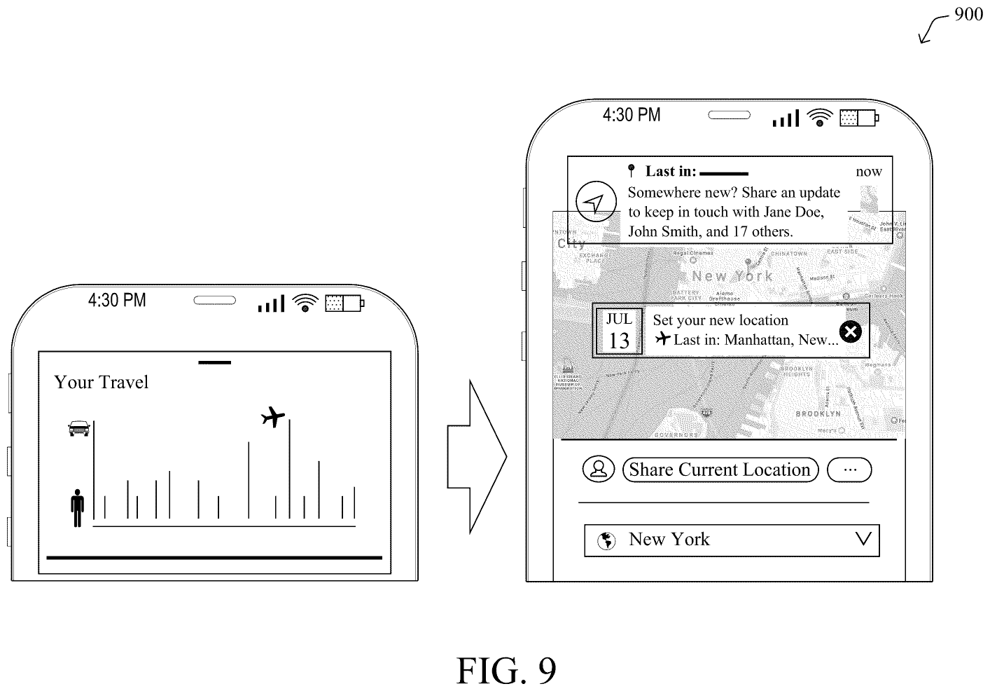

FIG. 9 illustrates an example of a location-focused social application;

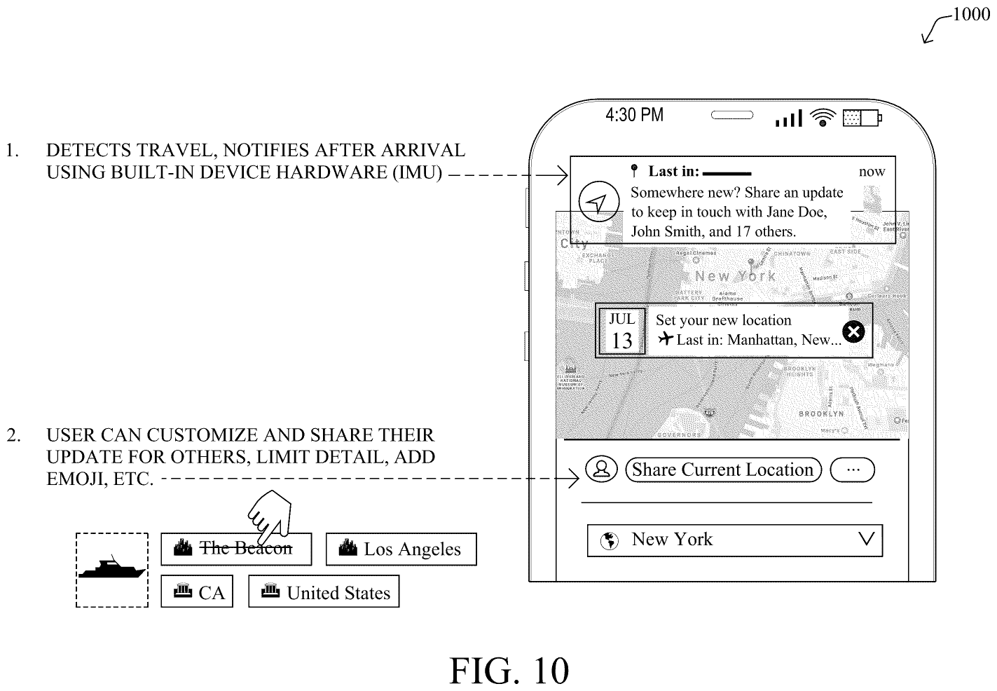

FIG. 10 illustrates an example of operation of the location-focused social application based on detection of aircraft travel by a mobile device and travel journey detection;

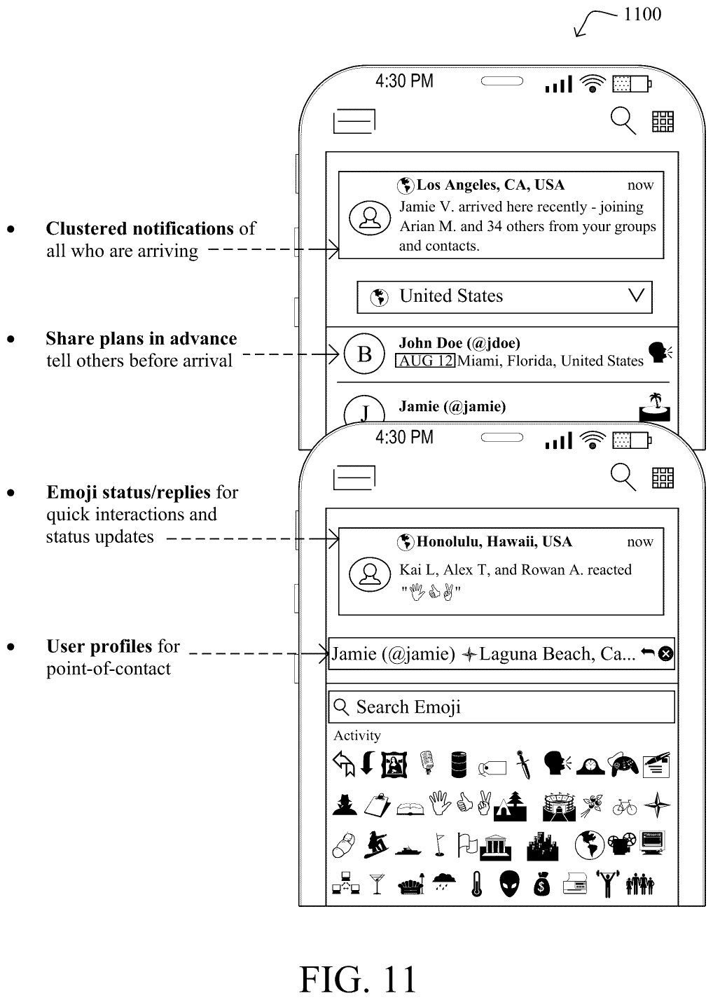

FIG. 11 illustrates an example of further features of the location-focused social application;

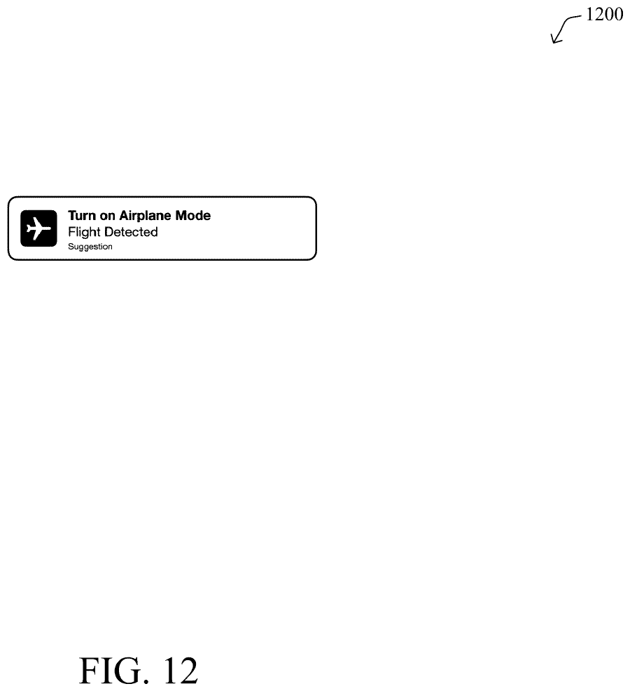

FIG. 12 illustrates an example user-targeted notification based on detection of aircraft travel by a mobile device and travel journey detection;

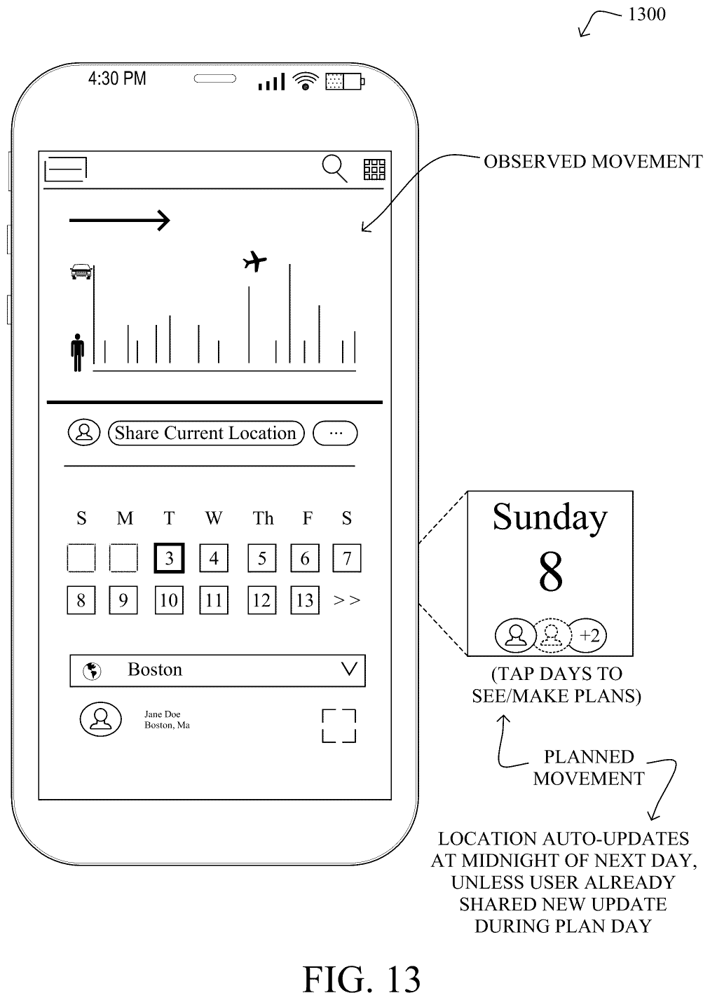

FIG. 13 illustrates an example of calendar-based augmentation of travel journey detection; and

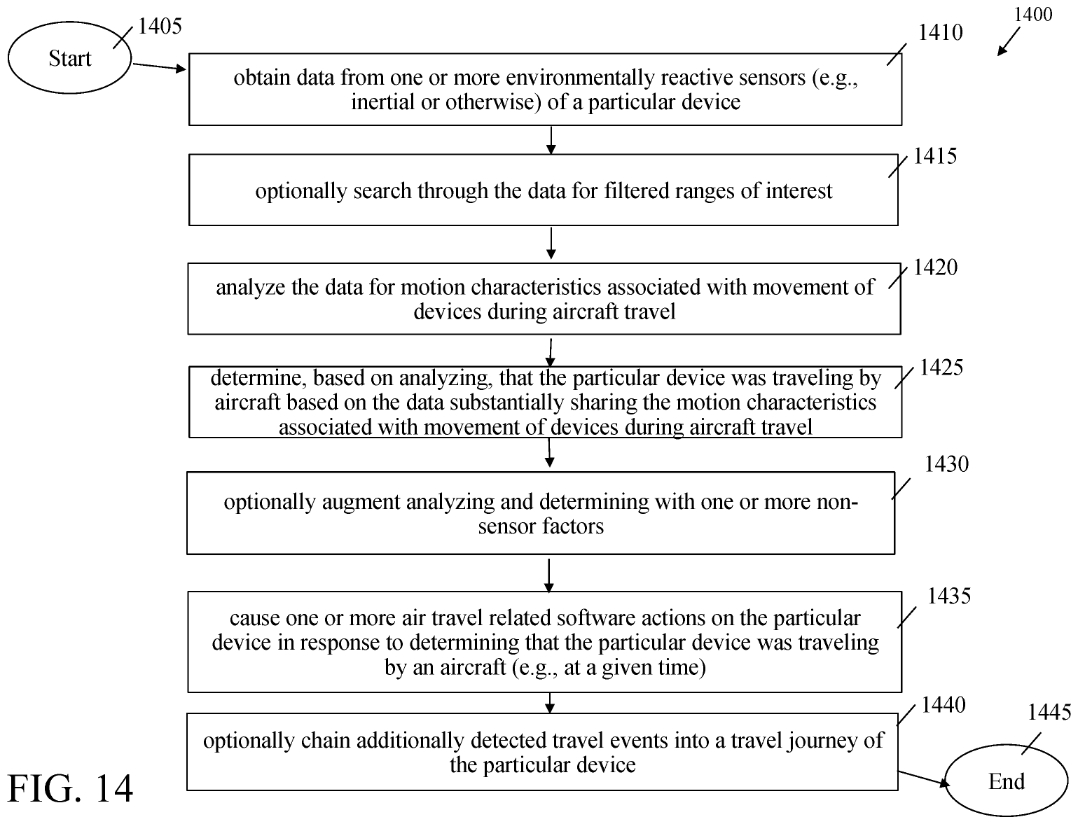

FIG. 14 illustrates an example procedure for detection of aircraft travel by a mobile device and travel journey detection.

### DESCRIPTION OF EXAMPLE EMBODIMENTS

A computer network is a distributed collection of nodes (e.g., transmitters, receivers, transceivers, etc.) interconnected by communication links and segments for transporting signals or data between the nodes, such as personal computers, workstations, mobile devices, servers, routers, or other devices. Many types of computer networks are available, including, but not limited to, local area networks (LANs), wide area networks (WANs), cellular networks, broadband networks, infrastructure or backhaul networks, public switched telephone networks (PSTNs), and many others.

FIG. 1 illustrates an example, and simplified, computer network 100. As shown, computer network 100 may contain various devices communicating over links 110 and an internetwork 115, such as end devices 120, servers 130, databases 140 (which may be part of servers 130 or in communication with and under the control of servers 130), and other devices as will be appreciated by those skilled in the art. Data transmissions 150 (e.g., packets, frames, messages, transmission signals, etc.) may be exchanged among the nodes/devices of the computer network 100 using predefined communication protocols where appropriate over links 110. In this context, a protocol consists of a set of rules defining how the nodes interact and exchange information with each other.

Notably, the computer network 100 may comprise various individual networks intercommunicating with each other, such as LANS, WANs, cellular/LTE networks, PSTN, and so on, and may include any number of wired or wireless links between the devices, accordingly. Note also that while links 110 are shown generically interconnecting with the internetwork 115, any number of intermediate devices (e.g., routers, switches, firewalls, etc.) may actually make up the composition of the network 100 and internetwork 115, and the view shown herein is merely a simplified illustration.

End devices 120 may comprise different types of devices, such as, e.g., personal computers, desktop computers, laptop computers, mobile devices, tablets, smartphones, wearable electronic devices (e.g., smart watches), smart televisions, set-top devices for televisions, workstations, smart vehicles, terminals, kiosks, automated teller machines (ATMs), applications running on such devices, and so on, often interfacing with human users, though not necessarily. For instance, end devices 120 may also comprise drones, automated vehicles, artificial intelligence “beings” or robots, internet of things (IoT) devices, and so on.

Servers 130 and/or databases 140 may comprise singular servers and/or databases, server and/or database farms, cloud-based server and/or database services, network attached storage, and any other type or configuration of computing devices that provides computing and/or storage services as will be appreciated by those skilled in the art. Servers 130 and/or databases 140 may be centralized (i.e., processing and/or storage occurring on a single device or within a single location of devices) or distributed/decentralized (i.e., processing and/or storage occurring across multiple devices or across a plurality of locations). Notably, for example, servers 130 and/or databases 140 may be deployed on the premises of an enterprise or may be cloud-based.

Note again that FIG. 1 is merely a simplified example of a computer network 100, and any suitable configuration of devices and their interconnects may be used in accordance with the techniques herein. For instance, data may be relayed between user devices in a “peer-to-peer”-like relationship via standard device-to-device communication (e.g., cellular, Wi-Fi, etc.), or according to an apps API via a collection of servers (which may validate but otherwise are unable to see the actual contents of the data due to secure end-to-end encryption). That is, in one embodiment, an API on the servers may support the secure communication between user end devices, where various databases provide support behind the servers (e.g., for the purpose of providing the relay and gating access to usernames, etc.). Other arrangements still may be made and utilized herein, including mesh designs, hub-and-spoke configurations, multi-server coordination and load-balancing, and so on, as will be appreciated by those skilled in the art.

FIG. 2 is a simplified schematic block diagram of an example computing device 200 that may be used with one or more embodiments described herein (e.g., end device 120, server 130, database 140, etc., and particularly a mobile device as an end device 120, as described in greater detail below). Illustratively, device 200 may generally include one or more communication interfaces 210, one or more processors 220, and a memory 240 interconnected by a system bus 250 or other dedicated circuitry, and is powered by a power supply system 260. Additionally, the device 200, where required, may comprise one or more user interfaces 230 configured to solicit and receive user input (input/output or “I/O” components, such as displays, keyboards, touchscreens, biometrics, and so on).

The communication interfaces 210 include the mechanical, electrical, and signaling circuitry for communicating data over wired and/or wireless links of a communication network.

The memory 240 includes a plurality of storage locations that are addressable by the processor(s) 220 for storing software programs and data structures associated with the embodiments described herein. The processor(s) 220 may comprise necessary elements or logic adapted to execute the software programs and manipulate the data structures 245. An operating system 242, portions of which are typically resident in memory 240 and executed by the processor(s) 220, functionally organizes the device by, among other things, invoking operations in support of software processors and/or services executing on the device. Illustratively, these software processes and/or services may include one or more functional processes 246 (e.g., specific to functionality of the device, such as various applications/apps, programs, features, and so on), and an example travel monitoring process 247 and social locational interaction process 248 that are configured to perform the operations described herein. In an embodiment, functional processes 246, in particular, may include processes for reading data from various sensors 270 incorporated into the device where such sensors may include but are not limited to satellite-based radio navigation (e.g., GPS) receivers 272 and an Inertial Measurement Unit, or IMU 274.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

### Detection of Aircraft Travel by a Mobile Device

As noted above, mobile phones (e.g., smartphones) or other mobile devices have become an integral part of modern society, where people take their mobile phones with them wherever they go. Additionally, mobile phones can be used to classify movement, such as running, biking, and driving, because they are equipped with a variety of sensors that can collect data about the user's movement. For example, a mobile phone's Inertial Measurement Unit (IMU) can be used to detect inertial movement of the mobile phone (or other device), and this data can then be analyzed to classify the type of movement observable to the mobile phone (e.g., running, biking, driving). An IMU, in particular, is an electronic device that measures and reports a device's specific force, angular rate, and sometimes the orientation of the body, using a combination of accelerometers, gyroscopes, and sometimes magnetometers. (Note that when a magnetometer is included, IMUs may be referred to as IMMUs.)

Using mobile phones to classify movement can have a variety of applications. For example, in the case of biking, it can be used to track a person's route, speed, and distance traveled, which can be useful for fitness tracking and training. In the case of driving, mobile phones can be used to track when a vehicle is either stopped or in motion, which can be useful for automobile navigation system calibration and other applications reacting to movement.

Additionally, by using mobile phones to classify movement, it is possible to gather data in a continuous and unobtrusive way, and to use that data for various purposes, such as to improve people's safety, to track their fitness and health, or to allow them to adjust software data and configurations, as well as social media updates based on recent changes in location.

Current solutions that track a user's location, however, suffer from a number of limitations. First, most apps that track users are generally intrusive, monitoring precise or imprecise location based on satellite-based radio navigation (e.g., GPS), which many people would prefer to keep private and avoid in order to save device battery power. Users, therefore, are forced to choose between functionality and reduced privacy or the risk of captured data being used improperly. Second, many apps cannot accurately distinguish between certain modes of transportation, particularly being unable to classify movement when a person is taking a flight, boarding a train, and so forth. Currently, that is, motion detection technology can only distinguish between a user walking, running, riding a bike, or riding in a car.

The techniques herein, therefore, provide a method for determining when a mobile device, and thus generally an associated user, is traveling by aircraft, as well as various features that may be addressed by corresponding location awareness of the device based on that aircraft travel detection, accordingly. Note that embodiments herein need not be limited to user-based travel, and may be based on device travel without a user, such as for product shipments, automated devices, or Internet of Things (IoT) implementations. Also, as described above, an example unified architecture may provide a solution to numerous issues faced by customers, and illustratively this same architecture may be used for the techniques herein.

This groundbreaking application not only addresses privacy concerns associated with constant location tracking, but also introduces a fresh perspective on travel-related interactions within the domain of social networking and device management. By combining motion data, sensor inputs, and device-specific APIs, the system herein offers a more efficient and privacy-conscious approach to detecting and managing travel events, particularly air travel, while enhancing the overall user experience and engagement.

Said differently, the proposed solution encompasses a multi-dimensional approach that combines mathematical precision with optional machine learning adaptability to detect and manage travel events comprehensively, specifically aircraft travel, which to date has not been solved other than by the techniques herein. The proposed solution also offers opportunities for integration with other apps, prioritizes user privacy, and explores the use of external wearable devices to enhance functionality and user engagement.

As described in greater detail below, the techniques herein revolve around the development of software that leverages a combination of motion data, sensor inputs, and device-specific APIs to detect and manage travel events, with a particular focus on air travel. Aircraft, in particular, generally are able to move at greater speeds and maneuver differently than other types of travel (e.g., because of a lack of obstacles and improved visibility), which can be detected by the techniques herein. The innovative technology herein may also be associated with a location-focused application that aims to transform the way users engage with social networking services (SNS) in the context of travel and proximity, while addressing key technical and user experience aspects.

The core functionality of the application centers on the detection of air travel commencement and termination through the analysis of motion data. This is achieved by utilizing the device's inertial measurement unit (IMU) sensors and optionally with built-in motion recognition features provided by other software or the device's operating system. Unlike traditional methods that rely heavily on location data for example sourced by GPS, this app can identify when a user is in transit, including by aircraft, without the need for continuous location tracking.

One of the key features of this innovative software is its ability to trigger a wide range of user-facing or system-level events based on travel events detected through its inputs. For instance, it can automatically adjust system settings, such as suggesting enabling of or automatically toggling an Airplane Mode or Flight Mode, when it detects that a user has commenced air travel. Additionally, the software (e.g., an associated app) can provide deferred notifications after travel concludes, encouraging users to share their travel updates and experiences on SNS or perform other relevant actions.

Furthermore, the application distinguishes itself by learning and adapting to user behavior patterns. For example, it can recognize when a user has not shared an update following specific travel modes, thereby further reducing user engagement and prompting them to share their experiences only in more relevant scenarios. This adaptive functionality encourages user participation by not over-engaging, and helps to ensure that the app remains user-centric.

Notably, as mentioned herein, the solution provided by the present disclosure encompasses a comprehensive approach that uses either manual mathematical techniques or machine learning, or both, to achieve the goal of detecting and managing travel events surrounding air travel, as well as other types of travel especially for the purposes of but not limited to avoiding false positive detection of air travel. This multifaceted strategy ensures versatility and robustness in detecting various events while maintaining a flexible implementation framework. For instance, the application can employ machine learning models or AI algorithms to analyze sensor data and recognize specific events. Alternatively, the techniques herein may utilize a series of weighted conditional formulas, processed within a rolling window of observed datasets and filtered using pre-qualifiers, qualifiers, and disqualifiers, to scan an array of sensor inputs for event detection. This approach caters to both developers comfortable with mathematical precision and those who prefer to utilize the capabilities of machine learning training across a variety of previously or ongoingly observed datasets. Moreover, certain aspects of the techniques herein may also rely on other inputs, such as parallel detections of movement by other IMU and sensor processing such as other applications on the same device or sibling device or software included as part of the core operating system of the devices, to disqualify flight events as well. For instance, walking steps or driving in a car could be a disqualifier that “terminates” the air travel without requiring further analysis of raw IMU data, accordingly.

The code implementation for this solution extends beyond the detection of travel by aircraft. It encompasses the entire flow of events that result from such detections. This holistic approach ensures a seamless user experience and comprehensive event handling, ranging from adjusting system settings to delivering notifications or triggering other software actions.

It is essential to highlight that while the implementation details may vary, the core invention revolves around the ability to detect and manage travel events efficiently, particularly aircraft travel, regardless of whether it relies on mathematical calculations or machine learning models. This flexibility ensures that the solution remains adaptable to future advancements and evolving user preferences.

Also, privacy is a paramount concern, and the application takes proactive measures to protect user data. Not only is GPS access or location information not required to determine travel events, but the techniques herein may also take other measures to ensure privacy, such as employing tokenized text to represent locations, allowing users to adjust which tokens are shared based on their privacy preferences while omitting location coordinates entirely in communications with other users. This approach ensures that sensitive location information remains secure while maintaining the utility of the application, enabling recipients to then resolve a location coordinate from the tokenized text shared as a result of a travel event that was originally generated without knowledge of that particular location coordinate.

Lastly, the incorporation of external wearable devices with IMUs or sensors is an important aspect of the solution. It allows for a distributed approach, where multiple devices can contribute to event detection and user interaction, as well as “sibling device” control based on the detection of travel (e.g., aircraft flights), accordingly. Some devices may not include all required or preferred sensors or processing hardware or software capabilities, but can work together to avoid redundant processing or in the event of outage or unavailability. For instance, a fitness band could signal an in-flight status to the user and trigger events on linked devices, enhancing the overall user experience and accessibility. In the alternative, detection of travel by aircraft on a user's phone may trigger an airplane mode on a peripheral device such as a watch or headphones, accordingly.

Operationally, the techniques herein (e.g., executed by processor 220 above) may be configured to receive one or more inputs from the sensors 270, particularly inertial inputs such as from an IMU, and may analyze the one or more inputs to determine one or more movement classification determination characteristics from the inputs (e.g., air travel or otherwise), where the one or more movement classification determination characteristics are representative of the movement patterns typically associated with travel by aircraft, as reflected by at least one or more inputs. The techniques herein may then further compute, based on the one or more inputs, a specific movement classification, such as, e.g., that the user is traveling by aircraft or otherwise.

For example, to determine air travel event characteristics, the techniques herein may analyze inputs from the sensors 270 to detect patterns of movement (qualifying events) and may disqualify any false positives. Specifically, to qualify events, the techniques herein may analyze acceleration curves to determine when a plane or other aircraft (and thus, one or more of the user's devices) has large shifts in altitude or ground acceleration as may be detected by the IMU (e.g., accelerometer, etc.), during airplane specific events such as takeoff, ascent, descent, landing, dropping to avoiding turbulence, etc. In general, extended periods of acceleration are unlikely to occur steadily in events other than air travel, with few exceptions of other extreme circumstances (e.g., roller coasters and thrill rides, etc.).

To eliminate false positives, such as a roller coaster event, the techniques herein may be configured to further distinguish whether the user is likely traveling by aircraft (with limited changes in direction given the intent of travel and accumulated acceleration) versus engaging in other types of activity (e.g., on a thrill ride with rapid and much more frequent changes in direction). Therefore, the techniques herein may be configured to detect and remove false positives (such as but not limited to roller coaster rides or extreme sports) by examining and classifying the acceleration measurements and optionally other measurements in combination to determine when a user is likely on an airplane.

For instance, as an additional measurement, the techniques herein may utilize barometric pressure sensed by device 200, which is a dedicated hardware sensor (of sensors 270). While high-altitude aircraft cabins are typically pressurized and may interfere with this reading, the presence of a rapid change in pressure in combination with the movement detected may be utilized by the techniques herein to qualify recorded movement as the movement of an aircraft.

The inputs or data for the techniques herein to determine the user is on a flight may include one or more of acceleration, magnetic field and magnetic dipole moment measurement, and spatial axis gyroscopic data from the gyroscope, accelerometer, and magnetometer of an inertial measurement unit (IMU), barometric data from a barometer, and optionally location information from location resolution hardware and software services such as a satellite-based radio navigation system (e.g., GPS).

In one embodiment, the location information may not be used by the techniques herein to determine that the user is traveling by aircraft. The ability to calculate or classify movement without location information such as but not limited to that sourced by satellite-based radio navigation system (e.g., GPS) is critical to obviate the events where the user may be on an aircraft and their location resolution hardware and software services are disabled or otherwise unable to provide accurate information about the user's position.

In another embodiment, the techniques herein may be configured to use other inputs and data such as whether notifications were delivered to the user based on other signals, is the user connected to the internet, how long ago were the movements detected, how long ago were they last notified, how long was the movement in question, if there were any other conflicting movements that suggest an interruption in that potential travel, etc.

FIG. 3 provides a simplified procedure 300 for classifying movement of a user (e.g., to be determined to be traveling by aircraft or otherwise) using the illustrative architecture described above.

The process in FIG. 3 starts at step 305 and moves on to step 310 where the system herein receives input from one or more sensors of the mobile device. In accordance with the embodiments highlighted above, the sensors may include an accelerometer, barometer, gyroscope, magnetometer, and optionally satellite-based radio navigation systems (e.g., GPS) or other location resolution hardware/software services. (Note that while satellite-based radio navigation systems such as GPS may be described herein as “sensors”, those skilled in the art will appreciated what such systems may be based on inputs from a variety of sensors, signals, software, and so on, and the use of the term “sensor” as it relates to encompass such satellite-based radio navigation systems “sensing a location” is not meant to limit the scope of the present disclosure or undermine the determination of a location based on deriving the location from received signals, accordingly.)

In one embodiment, various data filters may be used to scan over the sensor data using a “rolling window” in search of ranges of interest (e.g., “hot zones”) while applying optimized metrics and qualifiers/disqualifiers, in order to limit the potentially tremendous amount of noisy or irrelevant data from sensors (e.g., accelerometer or gyroscope data). For instance, the techniques herein may look for characteristics to qualify or disqualify ranges of signal data across a number of factors over time, illustratively doing the least “computationally expensive” factors if those factors can more rapidly disqualify signals sooner to save valuable resources, particularly on devices with limited resources (e.g., battery/CPU/etc.).

Specifically, to qualify or disqualify data as air travel for a specific period, the proposed methods rely on various sensor data criteria, including but not limited to the following, presented without any particular order of significance:
Detecting excessive or deficient alternations between high and low acceleration or gyroscopic changes/precessions;
Identifying anomalies in the difference in quantiles of acceleration or gyroscopic changes/precessions;
Analyzing data for unusually high or low levels of acceleration or gyroscopic changes/precessions;
Calculating the median of acceleration or gyroscopic changes/precessions and assessing it for excesses or deficiencies; and
Evaluating the standard deviation of acceleration or gyroscopic changes/precessions to determine if it falls outside of typical ranges.

These methods collectively provide a comprehensive approach to ascertain whether the recorded data corresponds to air travel during a specific time frame, enabling accurate event detection and classification.

For step 320, the data from the sensors may be utilized by the techniques herein to classify the nature of the movement detected by device 200, based upon the data received from the sensors. Step 320 may also include the false positive determination where results that may have erroneously suggested air travel are eliminated. At step 330, the techniques herein may output the results of the classification, e.g., specifically herein whether the user is on a flight, but in certain embodiments also whether the user is in a car, walking, biking, on a train, etc. (Note that in certain embodiments, different systems on the same device may be integrated in order to aggregate movement classifications, such as determining whether the user is on a flight in one system, but relying on other systems to determine that the user was in a car, and so forth.) Notably, as described in greater detail below, the result of this classification can then be used to trigger a location determination of the user in step 340, accordingly. The method is concluded at step 350.

FIG. 4 illustrates an example architecture 400 for classifying movement, particularly a scenario where a user may be walking, driving, on a flight, and so on (not shown for simplicity, such as on a train, on a marine vehicle, etc.), and the input data is classified accordingly to determine the mode of transportation of the user.

First, an Inertial Measurement Unit (IMU) 405 (or other sensors, as described herein) measures/observes the various changes in the device's measured force, angular rate, and the orientation and reports these changes to the operating system (OS 410). OS 410 records the IMU data (or other environmentally reactive sensor data as described herein) and makes it available to the app 450. At this juncture, app 450 may routinely classify 460 or reclassify this data and store events in its database 465 for the monitor 455 to observe and react to.

App 450 communicates with classifier 460 and data from the IMU is fed into scanner 470, which in turn passes “hot zone” results to qualifier 475 and subsequently disqualifier 480. Results not disqualified by disqualifier 480 are fed into database 465. As noted, monitor 455 is able to observe results from database 465. One of ordinary skill in the art would note that scanner 470 scans the data and passes its results through qualifier 475 to determine whether the movement may be indicative of a pattern associated with travel by aircraft (or another mode of transportation), such as characteristic changes in acceleration, pressure, altitude and the like (i.e., specific patterns indicative of aircraft travel). Disqualifier 480 receives the results from qualifier 475 and eliminates events that may cause a false positive such as a roller coaster ride, normal movements in or out of a different kind of vehicle, or bungie jumping, etc.

Monitor 455 observes and reacts to the data from the app 450 and the database 465 and queues internal app events regarding the associated movement, which may be categorized as common transit mediums such as for example flight 435, driving 440 or walking 445. The associated movements representing travel by aircraft or “flight” 435, driving 440 and walking 445 may then be fed into conditions 420, conditions 425 and conditions 430 respectively, to control whether effects of said movement trigger an event or outcome for the user. Gateway 415 may receive the data from conditions 420, conditions 425 and conditions 430, and consequently request that the operating system, OS 410, delivers a notification from the app to the user, indicative of the type of movement detected and prompting an action for the user to take in response. For example, as noted above, gateway 415 may limit when or whether notifications are delivered based on other signals, such as whether the user is connected to the internet, how long ago the movements were detected, how long ago the user was last notified in response to this or other movement or app events, the duration of the movement detected, and whether or not there were any other conflicting or simultaneous movements that suggest an interruption or other disqualifying condition regarding that potential travel, or whether travel is actively still continuing despite a detected event, etc.

Architecture 400 may thus be configured according to the techniques herein to process the available data, such as from environmentally reactive sensors primarily (e.g., inertial or otherwise), though also optionally based additionally on satellite-based radio navigation systems (e.g., GPS) or other location resolution hardware/software services, network connectivity, lengths of time between events, and so on, to classify movements of the user into one or more categorical modes of transportation, whether it be a type of movement that is already classified, categorized, and suggested by the OS 410 alongside the IMU data, or movements specifically classified according to the techniques herein. The techniques herein then apply policy-based algorithms to decide whether to notify the user of the classified mode of transportation, such as based on confidence, purpose, intent, priority, or any other chosen logic for notification and/or display.

Note that the architecture highlighted above may classify multiple modes of movement. The embodiment illustrated may classify movement associated with travel by aircraft, driving, and walking. However, one of ordinary skill in the art would understand that other embodiments may determine additional modes of movement such as, but not limited to, swimming, running, diving, being on a boat or a train, or other modes of transportation that may be discernible based on sensor input and interpretation according to the techniques herein. Additionally, other sensors may be used to feed the architecture such as sensors that may be worn like a smart watch or any electronic device that may communicate with a user's device or other portable electronic device.

FIGS. 5-6 illustrate example user interfaces 500 and 600 integrating the classified mode of transportation according to the techniques herein. In particular, as shown, various icons indicating modes of transportation (e.g., walking, driving, flying, resting) on a timeline (e.g., a day, a week, a month, optionally selectable) of a user, as well as other features such as locations on a map (e.g., sourced from location information or user-input based on prompts), locations of friends on a friends list, collected metrics of the modes of transportation (e.g., when last on a plane, how long walked, etc.). The user interface thus provides a mechanism for notification to a user about the classified modes of transportation, as well as other prompts for inputs or configurable outputs, such as triggering a notification regarding travel by aircraft, and a request for the user to let nearby groups of contacts or individual contacts or connections know that the user has recently traveled to their location, and so on.

According to the present disclosure, therefore, detection and analysis of location changes herein use a proprietary logic tree to prompt at a suitable (e.g., “the best time possible”) for UX conversion and relevancy. For example, detecting a change in walking or automotive driving patterns after leaving an aircraft versus while airborne may be beneficial to limit and trigger events in a timely manner. In other words, the techniques herein don't prompt a user for a flight confirmation based on what happens on the flight, but instead after the flight has been completed.

The techniques herein may also supersede events with other events. For example, if the system detects vehicular travel, but then air travel prior to the prompt for vehicular travel being delivered, the techniques herein may avoid prompting the user for the vehicular travel either at all or at least while they are in the air during their flight. The techniques herein may also “chain and stack” trips and motions together, e.g., linking multiple segments of travel even if not consistent or performed in series, etc. For instance, this may result in a prompt happening that would not have previously, or delay of a prompt if travel continues onward, etc.

Regarding machine learning, which may be used depending on what is being analyzed, the techniques herein may learn the user's behavior in a location prior to a change in the location. For instance, after setting a new location, the techniques herein may (for example) ignore driving patterns that did not in the past trigger a user updating their location since arriving in that location, but still prompt immediately for travel by aircraft or different types of driving or other ground transportation patterns that are more likely to be considered by the user for acting upon. Note, too, that machine learning may be used herein for certain detections that potentially, for example, are impractical as purely algorithmic, and not simply for learning from user behavior in a particular location. For instance, as may be appreciated by those skilled in the art, certain algorithmic changes are essentially impossible to develop while targeting a diverse audience without assistance from machine learning.

Other factors to be considered for determining travel, travel patterns, and location changes that may prompt sharing of a more specific location may be included or excluded herein. For instance, one such factor is taxiing behavior of the aircraft, while on the tarmac prior to being in the air or after landing. Also, for air travel, the techniques herein may look for recognizable classifications of acceleration and gyroscopic rotation and other measurable motion factors. Another signal not previously noted above may be such things as notable time zone changes delivered by the operating system to the app as a potential signal or confirmation, depending on the events that took place.

To restate the general concepts described herein in relation to the present disclosure and associated embodiments, the techniques herein pertain particularly to the detection of travel by aircraft using data obtained from one or more sensors integrated into a specific device. The process commences with the acquisition of sensor or other operating system provided data, which includes but is not limited to measurements from hardware, software, or firmware sensors residing within the particular device or any associated sibling device. These sensors encompass a range of capabilities, such as an Inertial Measurement Unit (IMU), accelerometer, barometric pressure sensor, gyroscope, and magnetometer, which collectively measure data related to acceleration, magnetic field moments, magnetic dipole moments, spatial axis gyroscopic data, and barometric pressure.

Notably, in certain implementations herein, detection of aircraft travel (or other input to assist in such detection, such as for further qualification and/or disqualification of the data) may use sensors and IMUs across various devices (e.g., interconnected user devices), and may also use “sensor fusion” techniques, which is the process of combining sensor data or data derived from disparate sources such that the resulting information has less uncertainty than would be possible when these sources were used individually. In one embodiment, for example, sensors may be selected for use interchangeably based on various factors such as prioritization of resources (e.g., to save battery), cleanliness of the data or noisiness of the data, or general quality of data (e.g., different devices may have different exposures, such as one might be in a bag with steady data versus on a user's wrist with noisy movement data to affect IMU readouts differently). Another factor may include the availability of data, as some devices may not have particular sensors at all. In another embodiment, for example, sensors may be combined for uncertainty reduction, clarification, noise filtering, “rolling window” timing-based data filtering determinations (as described herein), and otherwise.

The techniques herein may be based generally on comparing the acquired sensor data against characteristics of (e.g., a predefined signature representative of) the movement patterns typically associated with travel by aircraft. This comparison process employs an algorithm that may apply a series of weighted, conditional formulas to the data in a particular weighted order, allowing for the detection of air travel events and the classification of data that substantially matches the characteristics, accordingly.

In an alternative embodiment, the comparison step may leverage a machine learning model trained specifically for analyzing sensor data and detecting air travel events, thus enabling the classification of data as matching with known patterns pertinent to movement by aircraft or exceeding thresholds in other non-aircraft travel within particular known bounds. Additionally, the method may incorporate techniques for qualifying and disqualifying data to eliminate false positives. These qualification and disqualification processes account for various factors, including non-linear acceleration changes that may be associated with patterns of travel by aircraft.

Characteristically, it is important to note that aircraft travel is much different than other forms of travel. For instance, other forms of travel can occur within spaces defined by an aircraft (e.g., its passenger cabin) or even carried by an aircraft, such as cargo or other forms of passenger cabins. For example, walking, running, or in some cases even bicycling or driving, while absent of many ground conditions such as consistent RF availability or cellular networks, at a different pressure given the traveling altitude of the aircraft or its passenger cabin pressurization, but alongside free movement of the aircraft at altitude including but not limited to greater rotation and gravitational force equivalents given changes in altitude or direction and limited in-air obstacles compared to traveling on the ground, etc. As such, environmentally reactive sensors (such as inertial sensors of an IMU) generate much different signaling than they would if the device were sitting in a car/bus or on a bicycle that travels and likely accelerates in fewer dimensions (assuming a constant positioning/rotation of a user device for observation), and at much different rates (e.g., accelerations/changes) and to different ranges/amplitudes (e.g., gravitational force equivalents, speeds, directions, altitudes, pressures, etc.). More common travel mechanics such as walking, running, driving, or bicycling can typically be detected within or simultaneous to aircraft travel, and processes to do so may run in parallel to or in unison with detection of aircraft travel.

The specific mobile device, to which this method is applied, may encompass a variety of devices, including but not limited to smart phones, smart watches, fitness trackers, smart rings, tablets, and laptops. The method operates on the principle of “location without tracking,” meaning it avoids continuous tracking of the user through location services such as GPS, thereby preserving user privacy and optimizing device battery life. The app may generally remain active in the background of a user's device until motion indicative of travel is detected, at which point it triggers the execution of one or more software actions related to travel by aircraft on the particular mobile device.

These actions may occur either during travel by aircraft in response to takeoff, or after the flight in response to landing, depending on the embodiment. The software actions related to travel by aircraft encompass a range of functionalities, including notifying the user when significant journeys are detected, prompting for user behavior, asking the user whether to share a new location on a social network, adjusting application or system settings such as but not limited to Airplane Mode or Flight Mode, modifying application or system settings on sibling devices, or even causing effects in gameplay or other actions or events within other software on the particular device based on the detected travel by aircraft or other travel events. Note, too, that location services such as satellite-based radio navigation systems (e.g., GPS) may remain disabled, only enabling them in certain embodiments for coarse location determination, thereby obfuscating location precision. In one embodiment, precise user location may also be further protected through simply sharing a user-controlled portion of the resolved text-based locations, such as, e.g., city/state, or city/country names, without any other specifics.

To enhance accuracy and relevance, the methods herein may augment the comparison and determination steps herein with one or more non-sensor factors, such as internet connectivity, cellular connectivity, network associations, calendared plans, stored transit tickets, time-zone changes, and location or satellite-based radio navigation system data (e.g., GPS). This comprehensive approach ensures the reliable detection and classification of passenger flight events based on sensor data.

Moreover, the techniques herein may further provide the capability to chain multiple detected travel events into a continuous travel journey observed by the particular device, allowing for the execution of journey-relevant software actions (e.g., indications of complete user travel journeys, general transit reactivity, icons related to automobiles, trains, planes, bicycles, pedestrians, and so on).

Moreover, to further safeguard user privacy, the techniques herein may employ end-to-end encryption to protect location updates shared with others also using the app, ensuring that only authorized recipients can access this sensitive information. In particular, in this embodiment, even app servers need not be made aware of details of the user's shared locations, accordingly.

Notably, the techniques herein may extend beyond detecting travel by aircraft, but may also provide for one or more associated actions within a social application. For instance, this application may represent a unique approach to maintaining connections with groups and contacts in various locations while prioritizing user privacy and conserving device resources. Unlike most other location-tracking apps, as mentioned above, it operates on a “location without tracking” principle, ensuring that users' real-time locations are not continuously monitored or shared as a result of location information sourced from services such as satellite-based radio navigation system (e.g., GPS). Instead, the app responds to users' travel and transit activities by leveraging the inherent sensors and operating system conditions of their smart devices, offering a secure and privacy-conscious way to stay connected.

Key features of this illustrative accompanying app include:
Motion-Driven Detection: The app employs motion as the primary trigger for travel detection, distinguishing it from constant location tracking used by other applications. It remains dormant until new motion data is measured and recognized as significant transit, preserving user privacy and extending device battery life.
Customizable Updates: Upon detecting significant transit, the app notifies the user after their arrival at the destination, courtesy of built-in device hardware such as but not limited to the Inertial Measurement Unit (IMU). Users have the flexibility to customize an update before selectively sharing it with others, enabling them to control the level of detail and express themselves using emojis and other personal touches.
End-to-End Encryption: The app places a strong emphasis on security and privacy. It employs end-to-end encryption to ensure that location updates, shared within the app, are accessible only to the intended recipients. Not even the app's developer or company can access this sensitive information. Additionally, most user data is kept offline once delivered, further enhancing data privacy.
User-Controlled Sharing: Users have full control over who sees their location updates and when they are shared. This feature empowers individuals to maintain their privacy while selectively sharing their whereabouts with chosen groups or contacts.

As such, an app based on the techniques described herein reimagines how people can stay connected with their groups and contacts (e.g., friends, contacts, coworkers, fans, followers, etc.) amongst various locations without compromising their privacy. By utilizing motion detection and adhering to a “location without tracking” approach, it not only enhances user privacy but can also better preserve device battery life compared to other applications that track the user's actual location by employing radio technologies. The app's end-to-end encryption and user-controlled sharing settings ensure that location updates remain secure and solely accessible to authorized parties, making it a pioneering solution in the realm of location-focused communication.

Furthermore, the application's potential utility extends beyond individual use cases, offering opportunities for integration with other apps, such as but not limited to augmented reality gaming. Such games may offer unique gameplay experiences when near water or specific environments or landforms, but in this case the application could extend this behavior to offer unique experiences while traveling by aircraft. For example, it could serve as a core component or remote trigger for applications that can enable unique in-flight experiences such as capturing airborne creatures/characters in an augmented reality game. This underscores the versatility and potential market reach of the proposed solution.

FIG. 7 illustrates an example 700 of inertial sensors on a mobile device such as a phone. In a modern smartphone, for example, inertial sensors play a pivotal role in enabling a range of features and functionalities. These sensors, typically comprising of accelerometers and gyroscopes, serve as the device's internal motion detectors. Accelerometers measure changes in linear acceleration, allowing the phone to detect movements such as tilting, shaking, or acceleration in different directions. Gyroscopes, on the other hand, track angular velocity and orientation changes, providing crucial data for tasks like screen rotation, gaming, and augmented reality applications. Together, these inertial sensors empower smartphones to auto-rotate their screens, enable immersive gaming experiences, and enhance navigation through tilt and motion gestures. Additionally, they contribute to the accuracy of step counting in fitness apps and enable the detection of travel events, such as passenger flight takeoffs and landings, based on distinctive motion patterns. In essence, inertial sensors are the silent enablers behind the intuitive and responsive user experiences that have become synonymous with modern smartphones.

FIG. 8 illustrates an example GUI 800 of location sharing settings on a smart device. The graphical user interface (GUI) for location sharing settings on a smartphone offers users a crucial level of control and privacy when it comes to sharing their whereabouts. Within these settings, users have the option to select their preferred level of location sharing, ranging from never sharing their location to sharing it only when they actively choose to do so. This user-friendly interface typically presents a series of toggles or checkboxes that allow individuals to customize their location-sharing preferences. This level of control ensures that users can safeguard their privacy while still enjoying the benefits of location-focused services. By giving users the power to make informed decisions about when and how their location data is shared, these settings enhance overall user trust and satisfaction with their smartphones' capabilities.

FIG. 9 illustrates an example 900 of a location-focused social application. In particular, a location-focused social application offers users a dynamic way to connect and share their experiences with their social network. One of its standout features is its ability to detect when a user has arrived at a new location, especially after recognizing travel by aircraft through the software, as described in accordance with the techniques herein. For instance, different icons, shapes, colors, etc., may be used to readily indicate various modes of travel (e.g., walking, driving/riding, and flying) over a historical account of the user's journeys (e.g., recent, daily, weekly, zoomable window of time, etc.). This innovative functionality enables users to effortlessly share their current whereabouts with their social network, fostering real-time connections and enhancing the overall user experience. Whether it's sharing travel adventures, discovering new places, or simply staying connected with friends and family, this application harnesses the power of location data to facilitate meaningful interactions and provide a window into the user's world, making it a valuable tool for those who love to explore and share their experiences.

FIG. 10 illustrates an example 1000 of operation of the location-focused social application based on detection of aircraft travel by a mobile device and journey detection as described herein. For instance, the operation of the location-focused social application relies on cutting-edge detection of travel by a mobile device on aircraft and associated travel journey detection. In the first step, the app employs the built-in device hardware, such as the Inertial Measurement Unit (IMU), to accurately detect when a user is in transit, particularly traveling by aircraft to a new destination. Upon recognizing the conclusion of a journey, the application may promptly notify the user. This notification serves as a prompt for various actions and interactions, enhancing user engagement. Subsequently, in the second step, users are given the freedom to customize and share their location updates within their social network in the location-focused social application (or other software or suitable third-party social network app). They have the flexibility to control the level of detail shared (e.g., limiting specific location details or other details), add expressive emojis, and curate their updates to best reflect their experiences. This seamless process not only ensures privacy and user autonomy but also fosters a vibrant and interactive community where individuals can connect, share, and engage on their terms, making the location-focused social application a versatile and user-centric platform.

FIG. 11 illustrates an example 1100 of further features of the location-focused social application. In particular, beyond its core functionality, the location-focused social application herein offers a range of additional features that elevate the user experience. One notable feature includes clustered notifications, which intelligently group notifications of arriving or nearby users in a given location, providing a streamlined, focused, and clutter-free update for the user. Moreover, users have the option to share their plans in advance, allowing them to inform their network of their upcoming arrival and plans before they even reach their destination. This proactive communication fosters seamless coordination and anticipation among friends and acquaintances. The application also supports user profiles, facilitating point-of-contact by providing essential information and a centralized hub for a user's connections. Furthermore, quick interactions and status updates are made even more expressive and engaging through the incorporation of emoji status and replies. These features collectively create a dynamic and user-friendly environment that encourages meaningful connections, efficient communication, and a sense of community among users of the location-focused social application.

FIG. 12 illustrates an example notification 1200 based on aircraft travel and journey detection. In particular, when it comes to enhancing the travel experience, user notifications on a user's smartphone or other device (e.g., a local notification) may leverage the innovative detection of travel by aircraft and associated journey herein. These timely notifications serve as intelligent prompts, guiding users on when to enable or disable Airplane Mode or Flight Mode to enable or disable RF communication and triggering other in-flight effects and restrictions. By seamlessly integrating with a user's travel journey, the techniques herein ensure that users can maximize their in-flight connectivity or comply with necessary restrictions with reduced hassle. This level of automation and convenience enhances the overall travel experience by either reminding a user of their responsibilities or cellular availably, or else by auto-configuring a device (if allowed by device restrictions) into or out of such modes, accordingly.

Lastly, as mentioned above, the techniques herein may also leverage calendaring, saved transit tickets, or other indicators of travel. For instance, FIG. 13 illustrates an example 1300 of calendar-based augmentation of passenger flight and travel journey detection. For example, a calendar-based augmentation of travel by aircraft and journey detection takes user planning and interaction to a new level. This “plans calendar” feature empowers users to set their location in advance, allowing them to proactively share their whereabouts with others and themselves. By seamlessly integrating with the locally observed movement detection herein, this feature not only confirms travel plans but also provides users with the ability to highlight their travel plans for themselves and when shared with others. This feature fosters social connectivity, enabling users to see and connect with friends or make plans for specific days. Additionally, the system intelligently combines both planned and detected movement data to automatically update the user's location, ensuring accuracy and timely updates, especially for upcoming travel days. For example, users may be able to “pre-declare” their travel, which may be used to affect the events that transpire thereafter in the app described herein. For instance, as an enhancement to notifying users that they may want to update their location, the techniques herein may confirm the travel journey with different language, such as “You are here” or “Your arrival is confirmed” or “Welcome to . . . ”, as opposed to more generic messages if the user did not pre-declare a location, such as “Last in . . . , are you somewhere new” or “We detected a flight, share new location?”, etc.

This calendar-based approach adds a seamless layer of convenience and flexibility, making it easier than ever for users to stay connected and informed while enhancing their overall travel experience. The techniques herein can also provide assistance in booking transit or accommodations given the dates of a user's upcoming travel, or that of groups and contacts connected with that user in the app. In some cases, the app or its service provider may deliver push notifications of travel deals or incentives based on subscribed locations within particular date ranges of interest to the user of the app based on their own travel dates or history, or those of others they are connected with.

In closing, FIG. 14 illustrates an example simplified procedure for detection of aircraft travel by a mobile device and travel journey detection in accordance with one or more implementations described herein. For example, a non-generic, specifically configured device (e.g., device 200) may perform procedure 1400 by executing stored instructions (e.g., process 247 and/or process 248). The procedure 1400 may start at step 1405, and continues to step 1410, where, as described in greater detail above, the techniques herein obtain data from one or more environmentally reactive sensors (e.g., inertial or otherwise, though specifically non-location-focused or other communication protocol sensors) sensors on a specific device. These sensors may encompass a spectrum of options, including but not limited to accelerometers, gyroscopes, and barometric pressure sensors. Notably, as detailed above, the data from the environmentally reactive sensors (e.g., inertial sensors) sensors indicate motion-related conditions of device movement, derived from local device hardware sensors, without engagement of methods to resolve the actual coarse or precise location of the device, such as satellite-based radio navigation systems (e.g., GPS) or other types of locating services (e.g., cellular or RF reference or triangulation, or near-field communication (NFC) or Bluetooth® technologies that offer location precision etc.).

In one embodiment, the data obtained in step 1410 may undergo a qualification process to determine its relevance and accuracy. False positives may also be systematically eliminated from consideration. An essential criterion for data evaluation involves accounting for changes in directions atypical to travel by aircraft.

As described herein, the device under consideration may belong to the category of smartphones, smartwatches, fitness trackers, smart rings, tablets, or laptops. Sensor measurements and/or resultant data may also be from various sources, including hardware, software, or firmware, residing either on the specific device or an associated sibling device (e.g., watch, headphones, fitness tracker smart ring, etc.). These sensors, particularly environmentally reactive sensors (e.g., inertial or otherwise) encompass an array that includes but is not limited to an Inertial Measurement Unit (IMU), accelerometer, barometric pressure sensor, gyroscope, and magnetometer, or still other sensors, separately or in combinations thereof. Data acquisition can occur either directly from these sensors or through the device's operating system via the application programming interface (API).

Optionally, in one embodiment, in step 1415, the techniques herein may search through the data to identify filtered ranges of interest, as described above.

Step 1420 involves analyzing the data for motion characteristics associated with movement of devices during aircraft travel. These characteristics, in particular, serve as distinctive markers of flight-related movements. In one implementation, the analysis process employs a structured algorithm, which adheres to a specific set of weighted conditional formulas. These formulas may dictate the order and significance of factors considered during the analysis. To further enhance accuracy, machine learning techniques may also, or alternatively, be employed. For instance, a machine learning model herein may be trained to recognize movement events and classify data that aligns with these predefined motion characteristics associated with movement of devices during aircraft travel.

The characteristics themselves may be based on the detection of alterations in acceleration, altitude, angles, rotations, directions, and barometric pressure—distinctive indicators (e.g., signatures) of takeoff, landing, or rapid changes in altitude during travel by aircraft. Notably, these characteristics may also incorporate nuanced factors such as the rate of acceleration change, alternation between high and low acceleration, gyroscopic precession, quantile differences, and threshold exceedances within the data.

Upon concluding the analysis process, a determination is made in step 1425 regarding whether the specific device was indeed traveling by aircraft. This decision may be based on a given portion of the data substantially sharing the motion characteristics associated with movement of devices during aircraft travel, as described herein.

In the pursuit of precision, in one embodiment herein, in step 1430 the determination may optionally be augmented with “non-sensor factors” (implying unrelated to the environmentally reactive sensors herein). These factors may encompass a spectrum of considerations, including internet and cellular connectivity, network associations, calendared plans, stored transit tickets, alterations in time zone information provided by the operating system, radio-frequency-derived location data including that from satellite-based radio navigation systems (e.g., GPS), among others such as externally-obtained location information.

Should the determination confirm that the device was traveling by aircraft (i.e., in response to determining that the particular device was traveling by an aircraft at a time associated with the given portion of the data), appropriate “air travel related software actions” may be initiated in step 1435. These actions can be executed during the flight, immediately following takeoff, during rapid changes in altitude, or upon the aircraft's landing. As described herein, these actions are multifaceted, encompassing any configured actions such as user notifications, suggestions for user behavior, inquiries regarding the sharing of location on social networks, adjustments to the device's mode (e.g., Airplane Mode or Flight Mode), alterations to settings on connected sibling devices, and even in-app actions such as gameplay. Notably, in certain embodiments herein, the execution of these actions may be delayed until after the aircraft has safely landed or after an entire travel journey has concluded (e.g., driving away from the airport or transit station to a destination), avoiding premature notifications or settings changes.

Furthermore, in an additional embodiment, detected travel events may be chained together in optional step 1440, forming a cohesive travel journey for the device. This approach enables the execution of journey-based actions on the device, further enhancing the user experience and interaction possibilities. For example, in one embodiment, step 1440 may affect the delivery of events in step 1435. For instance, if the user is driving in a car after a flight, for example, the techniques herein may determine that the user (the user's device) is no longer airborne, but rather than prompt them about the flight immediately, the techniques herein may wait until a drive to their destination is over. Other journey-based travel events and actions may be made in accordance with various embodiments herein, and those mentioned above are merely examples that are not meant to limit the scope of the present disclosure.

The procedure may then end at step 1445.

It should be noted that while certain steps within procedure above may be optional as described above, the steps shown in the procedure are merely examples for illustration, and certain other steps may be included or excluded as desired. Further, while a particular order of the steps is shown, this ordering is merely illustrative, and any suitable arrangement of the steps may be utilized without departing from the scope of the implementations herein.

Advantageously, the techniques described herein thus provide for detection of aircraft travel by a mobile device, associated travel journey detection, and a corresponding location-focused social application. In particular, according to one or more embodiments described herein, methods and/or apparatus are shown for using various sensors on a device and analyzing the data received from those sensors to classify movement as that of movement associated with different modes of transportation. In one specific embodiment, the mode of transportation determined is travel by aircraft in particular, when the data received indicates changes such as recognizable patterns in acceleration, altitude and pressure that are common during air travel.

In particular, motion of a user device may be analyzed for the purposes of delaying location lookup such as by satellite-based radio navigation systems (e.g., GPS), in the interest of both privacy and resource consumption such as but not limited to the user's cellular data and device battery. That is, the motion analysis may be configured to always run on device as a system service, but satellite-based radio navigation systems (e.g., GPS) or radio tower triangulation requires additional radio use of the device, and thus may be delayed, accordingly. For instance, with this model, first a user moves or travels, and then the system or user can use the radios to update the location more precisely (with use of location services such as satellite-based radio navigation systems or radio tower triangulation) when it is appropriate, versus whenever or all of the time or overtly frequently even outside of significant transit within the scope of interest of this type of software application.

Additionally, other social media update tools can be frustrating to users because users frequently miss others' updates distributed in suboptimal or non-location-focused formats, forget to share their own location-related updates, or do not want to share their location to a particular non-location-focused social medium at all. The present techniques, therefore, provide a valuable balance between functionality, privacy, intent, and relevance, accordingly.

The techniques herein revolutionize the detection of travel by aircraft through the innovative utilization of non-radio sensors, enabling efficient and privacy-conscious tracking of travel events without continuous location monitoring through services such as satellite-based radio navigation systems (e.g., GPS). The present disclosure therefore offers a versatile and adaptable approach that combines mathematical algorithms with machine learning, resulting in accurate and user-centric air travel event detection on mobile devices.

Illustratively, the techniques described herein may be performed by hardware, software, and/or firmware, such as in accordance with a process, which may include computer executable instructions executed by a processor (of a particular correspondingly operative computing device) to perform functions relating to the techniques described herein, e.g., in conjunction with other devices which may have correspondingly configured processes depending upon the functionality of the device, as described above (e.g., a user device, sensors built into a mobile device, external sensors, and so on).

It should also be noted that the steps shown and described in the procedures above are merely examples for illustration, and certain other steps may be included or excluded as desired. For instance, other steps may also be included generally within procedures above as described herein. For example, such steps (whether additional steps or furtherance of steps already specifically illustrated above) may include such things as: how the data is analyzed, how verification of the movement occurs, how false positives are determined and eliminated, and so on. Further, while a particular order of the steps is shown, this ordering is merely illustrative, and any suitable arrangement of the steps may be utilized without departing from the scope of the embodiments herein. Moreover, while procedures may be described separately, certain steps from each procedure may be incorporated into each other procedure, and the procedures are not meant to be mutually exclusive.

According to one or more embodiments herein, an illustrative method may comprise: obtaining, by a process, data from one or more environmentally reactive sensors (e.g., inertial or otherwise) of a particular device; analyzing, by the process, the data for motion characteristics associated with movement of devices during aircraft travel; determining, by the process and based on analyzing, that the particular device was traveling by aircraft based on a given portion of the data substantially sharing the motion characteristics associated with movement of devices during aircraft travel; and causing, by the process, one or more air travel related software actions on the particular device in response to determining that the particular device was traveling by an aircraft at a time associated with the given portion of the data.

In one embodiment, causing the one or more air travel related software actions occurs while traveling by aircraft in response to a takeoff.

In one embodiment, causing the one or more air travel related software actions occurs after traveling by aircraft in response to a landing.

In one embodiment, analyzing is based on an algorithm that applies a series of weighted, conditional formulas in a particular weighted order on the data.

In one embodiment, analyzing comprises: applying a machine learning model trained to classify the data as matching the motion characteristics associated with movement of devices during aircraft travel.

In one embodiment, the method further comprises one or both of: qualifying the data; or disqualifying false positives from the data. In one embodiment, one or both of qualifying or disqualifying is based in part on accounting for changes in directions atypical to travel by aircraft.

In one embodiment, the particular device is selected from a group consisting of: a smart phone, a smart watch, a fitness tracker, a smart ring, a tablet, and a laptop.

In one embodiment, the one or more environmentally reactive sensors comprise one or more of hardware, software, or firmware sensors on one or both of the particular device or an associated sibling device.

In one embodiment, the one or more environmentally reactive sensors are selected from a group consisting of: inertial sensors, an inertial measurement unit, an accelerometer, a barometric pressure sensor, a gyroscope, and a magnetometer.

In one embodiment, the data is selected from a group consisting of: acceleration, magnetic field moment measurement, magnetic dipole moment measurement, spatial axis gyroscopic data, altitude, and barometric pressure.

In one embodiment, the method further comprises: searching through the data for filtered ranges of interest to analyze.

In one embodiment, the motion characteristics associated with movement of devices during aircraft travel are based on changes to one or more of acceleration, altitude, angle, rotation, direction, or barometric pressure in a manner reflective of either takeoff, landing, or rapid changes of altitude of an aircraft.

In one embodiment, the method further comprises: augmenting analyzing and determining with one or more non-sensor factors. In one embodiment, the one or more non-sensor factors are selected from a group consisting of: internet connectivity, cellular connectivity, network associations, calendared plans, stored transit tickets, alterations in time zone information provided by an operating system, radio-frequency-derived location determinations; and externally-obtained location information.

In one embodiment, the one or more air travel related software actions comprise notifying a user of a detected transportation journey to prompt user behavior.

In one embodiment, the one or more air travel related software actions comprise asking a user whether to share a new location of the particular device to a social network or other software. In one embodiment, the method further comprises: enabling a satellite-based radio navigation system or other location-resolution service or resource to determine at least a coarse location of the particular device to share to the social network.

In one embodiment, the method further comprises: obfuscating precision of the new location of the particular device to share to the social network by sharing a text-only indication of the new location.

In one embodiment, the one or more air travel related software actions comprise one of either: requesting whether a user would like the particular device to either enable or disable an Airplane Mode or Flight Mode; or auto-adjusting the particular device to either enable or disable the Airplane Mode or Flight Mode.

In one embodiment, the one or more air travel related software actions comprises adjusting one or more settings on a sibling device of the particular device.

In one embodiment, the one or more air travel related software actions comprises causing one or more software gameplay actions within an application on the particular device based on the particular device traveling by the aircraft.

In one embodiment, causing is delayed until after detecting landing of the aircraft. In one embodiment, causing is further delayed until after detecting an end of a travel journey of the particular device based on detecting chained travel events.

In one embodiment, the method further comprises: chaining additionally detected travel events into a travel journey of the particular device, wherein the one or more air travel related software actions comprise one or more journey-based software actions on the particular device.

In one embodiment, the data is obtained from an operating system application programming interface or directly from the one or more environmentally reactive sensors, or both.

In one embodiment, the motion characteristics associated with movement of devices during aircraft travel are based on one or more of: alternation between high and low acceleration, alternation between high and low gyroscopic precessions, a difference in quantiles of acceleration, a difference in quantiles of gyroscopic precessions, surpassing high or low acceleration thresholds, surpassing high or low gyroscopic precession thresholds, a median of acceleration, a median of gyroscopic precessions, a standard deviation of acceleration, or a standard deviation of gyroscopic precessions.

According to one or more embodiments herein, an illustrative apparatus may comprise: one or more network interfaces to communicate with a computer network; a processor coupled to the one or more network interfaces and adapted to execute one or more processes; and a memory configured to store a process that is executable by the processor, the process, when executed, operable to perform a method comprising: obtaining data from one or more environmentally reactive sensors of a particular device; analyzing the data for motion characteristics associated with movement of devices during aircraft travel; determining, based on analyzing, that the particular device was traveling by aircraft based on a given portion of the data substantially sharing the motion characteristics associated with movement of devices during aircraft travel; and causing one or more air travel related software actions on the particular device in response to determining that the particular device was traveling by an aircraft at a time associated with the given portion of the data.

According to one or more embodiments herein, an illustrative tangible, non-transitory, computer-readable medium having computer-executable instructions stored thereon that, when executed by a processor on a computer, may cause the computer to perform a method comprising: obtaining data from one or more environmentally reactive sensors of a particular device; analyzing the data for motion characteristics associated with movement of devices during aircraft travel; determining, based on analyzing, that the particular device was traveling by aircraft based on a given portion of the data substantially sharing the motion characteristics associated with movement of devices during aircraft travel; and causing one or more air travel related software actions on the particular device in response to determining that the particular device was traveling by an aircraft at a time associated with the given portion of the data.

While there have been shown and described illustrative embodiments, it is to be understood that various other adaptations and modifications may be made within the scope of the embodiments herein. For example, though the disclosure was often described with respect to a user device, such as a cellphone or smart phone, those skilled in the art should understand that this was done only for illustrative purpose and without limitations, and the techniques herein may be used for any portable electronic device that can receive the minimum amount of data necessary to assist in location determinations (e.g., to determine whether or not a user has boarded an aircraft that has begun to transport them and their device, etc.). Furthermore, while the embodiments may have been demonstrated with respect to certain communication environments, physical environments, or device form factors, other configurations may be conceived by those skilled in the art that would remain within the contemplated subject matter of the description above.

Also, while certain types of devices have been described as either “smart devices”, “mobile devices”, “user devices”, “sibling devices”, “peripheral devices”, and so on, the present disclosure is equally applicable for offering one or more aspects of the techniques herein and the corresponding functionalities either as a primary device or a secondary device. That is, a device traditionally classified as a sibling or peripheral device, such as a fitness tracker bracelet or ring, may act independently as a “primary device” herein to detect aircraft travel and to adjust one or more settings or features, accordingly (e.g., displaying a plane icon on a fitness tracker to indicate a travel event or being in an Airplane Mode or Flight Mode on that device). Additionally, while certain implementations described above have mentioned processes, software, and/or apps performing certain aspects of the techniques herein, the embodiments herein may be performed by a standalone software process/app receiving data from sensors directly or from an operating system (e.g., raw, pre-processed, or processed), or by an operating system with built-in functionality to perform the techniques herein, accordingly.

Further, while analysis methods for the various inputs have been noted above, other factors/inputs may be used in accordance with the techniques herein that are not specifically mentioned. Similarly, while certain actions have been listed with regard to sensing data received from the sensors to be analyzed, in fact, other analyzing actions may be taken with the scope of the present disclosure, and those specifically mentioned are non-limiting examples. Also, other applications for the techniques herein may be contemplated, such as awarding digital collectibles (e.g., location-focused in-app collectibles), social customizations, and game-like interactions not specifically mentioned herein may be established based on the travel journey, location determination, or other detectable events according to the techniques herein.

Moreover, despite the innovative approach of the techniques herein, the development of this software acknowledges certain limitations, particularly on operating systems that have platform restrictions. For instance, live detection based on IMU or sensor data may be constrained for third-party apps running on certain operating systems, which necessitates the use of historic motion data and periodic runtime access. This limitation affects the app's design on such operating systems but provides opportunities for various implementations based on platform-specific constraints. As such, while certain implementations described above may be based on real-time analysis of data, other implementations within the scope of the techniques herein may be based on historical, past, or delayed data, without any detriment to the calculations herein aside from delay in enacting any associated actions in response to detection of particular travel journeys (e.g., travel by aircraft, in particular).

The foregoing description has been directed to specific embodiments. It will be apparent, however, that other variations and modifications may be made to the described embodiments, with the attainment of some or all of their advantages. For instance, it is expressly contemplated that certain components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A method, comprising:
obtaining, by a process, data from one or more environmentally reactive sensors of a particular device;
analyzing, by the process, the data for motion characteristics associated with movement of devices during aircraft travel;
determining, by the process and based on analyzing, that the particular device was traveling by aircraft based on a given portion of the data substantially sharing the motion characteristics associated with movement of devices during aircraft travel; and
causing, by the process, one or more air travel related software actions on the particular device in response to determining that the particular device was traveling by an aircraft at a time associated with the given portion of the data.

2. The method as in claim 1, wherein causing the one or more air travel related software actions occurs while traveling by aircraft in response to a takeoff.

3. The method as in claim 1, wherein causing the one or more air travel related software actions occurs after traveling by aircraft in response to a landing.

4. The method as in claim 1, wherein analyzing is based on an algorithm that applies a series of weighted, conditional formulas in a particular weighted order on the data.

5. The method as in claim 1, wherein analyzing comprises:
applying a machine learning model trained to classify the data as matching the motion characteristics associated with movement of devices during aircraft travel.

6. The method as in claim 1, further comprising one or both of:
qualifying the data; or
disqualifying false positives from the data.

7. The method as in claim 6, wherein one or both of qualifying or disqualifying is based in part on accounting for changes in directions atypical to travel by aircraft.

8. The method as in claim 1, wherein the particular device is selected from a group consisting of: a smart phone, a smart watch, a fitness tracker, a smart ring, a tablet, and a laptop.

9. The method as in claim 1, wherein the one or more environmentally reactive sensors comprise one or more of hardware, software, or firmware sensors on one or both of the particular device or an associated sibling device.

10. The method as in claim 1, wherein the one or more environmentally reactive sensors are selected from a group consisting of: inertial sensors, an inertial measurement unit, an accelerometer, a barometric pressure sensor, a gyroscope, and a magnetometer.

11. The method as in claim 1, wherein the data is selected from a group consisting of: acceleration, magnetic field moment measurement, magnetic dipole moment measurement, spatial axis gyroscopic data, altitude, and barometric pressure.

12. The method as in claim 1, further comprising:
searching through the data for filtered ranges of interest to analyze.

13. The method as in claim 1, wherein the motion characteristics associated with movement of devices during aircraft travel are based on changes to one or more of acceleration, altitude, angle, rotation, direction, or barometric pressure in a manner reflective of either takeoff or landing of an aircraft.

14. The method as in claim 1, further comprising:
augmenting analyzing and determining with one or more non-sensor factors.

15. The method as in claim 14, wherein the one or more non-sensor factors are selected from a group consisting of: internet connectivity, cellular connectivity, network associations, calendared plans, stored transit tickets, alterations in time zone information provided by an operating system, radio-frequency-derived location determinations; and externally-obtained location information.

16. The method as in claim 1, wherein the one or more air travel related software actions comprises notifying a user of a detected transportation journey to prompt user behavior.

17. The method as in claim 1, wherein the one or more air travel related software actions comprises asking a user whether to share a new location of the particular device to a social network.

18. The method as in claim 17, further comprising:
enabling a satellite-based radio navigation system or other location-resolution service or resource to determine at least a coarse location of the particular device to share to the social network.

19. The method as in claim 17, further comprising:
obfuscating precision of the new location of the particular device to share to the social network by sharing a text-only indication of the new location.

20. The method as in claim 1, wherein the one or more air travel related software actions comprise one of either: requesting whether a user would like the particular device to either enable or disable an Airplane Mode or Flight Mode; or auto-adjusting the particular device to either enable or disable the Airplane Mode or Flight Mode.

21. The method as in claim 1, wherein the one or more air travel related software actions comprise adjusting one or more settings on a sibling device of the particular device.

22. The method as in claim 1, wherein the one or more air travel related software actions comprises causing one or more software gameplay actions within an application on the particular device based on the particular device traveling by the aircraft.

23. The method as in claim 1, wherein causing is delayed until after detecting landing of the aircraft.

24. The method as in claim 23, wherein causing is further delayed until after detecting an end of a travel journey of the particular device based on detecting chained travel events.

25. The method as in claim 1, further comprising:
chaining additionally detected travel events into a travel journey of the particular device, wherein the one or more air travel related software actions comprise one or more journey-based software actions on the particular device.

26. The method as in claim 1, wherein the data is obtained from an operating system application programming interface or directly from the one or more environmentally reactive sensors, or both.

27. The method as in claim 1, wherein the motion characteristics associated with movement of devices during aircraft travel are based on one or more of: alternation between high and low acceleration, alternation between high and low gyroscopic precessions, a difference in quantiles of acceleration, a difference in quantiles of gyroscopic precessions, surpassing high or low acceleration thresholds, surpassing high or low gyroscopic precession thresholds, a median of acceleration, a median of gyroscopic precessions, a standard deviation of acceleration, or a standard deviation of gyroscopic precessions.

28. An apparatus, comprising:
one or more network interfaces to communicate with a computer network;
a processor coupled to the one or more network interfaces and adapted to execute one or more processes; and
a memory configured to store a process that is executable by the processor, the process, when executed, operable to perform a method comprising:
obtaining data from one or more environmentally reactive sensors of a particular device;
analyzing the data for motion characteristics associated with movement of devices during aircraft travel;
determining, based on analyzing, that the particular device was traveling by aircraft based on a given portion of the data substantially sharing the motion characteristics associated with movement of devices during aircraft travel; and
causing one or more air travel related software actions on the particular device in response to determining that the particular device was traveling by an aircraft at a time associated with the given portion of the data.

29. A tangible, non-transitory, computer-readable medium having computer-executable instructions stored thereon that, when executed by a processor on a computer, cause the computer to perform a method comprising:
obtaining data from one or more environmentally reactive sensors of a particular device;
analyzing the data for motion characteristics associated with movement of devices during aircraft travel;
determining, based on analyzing, that the particular device was traveling by aircraft based on a given portion of the data substantially sharing the motion characteristics associated with movement of devices during aircraft travel; and
causing one or more air travel related software actions on the particular device in response to determining that the particular device was traveling by an aircraft at a time associated with the given portion of the data.
